(19) United States
(12) Patent Application Publication
(10) Pub. No.: US 2020/0267309 A1
(43) Pub. Date: Aug. 20, 2020

(54) FOCUSING METHOD AND DEVICE, AND READABLE STORAGE MEDIUM

(71) Applicant: SZ DJI TECHNOLOGY CO., LTD., Shenzhen (CN)

(72) Inventors: Xuyang FENG, Shenzhen (CN); Cong ZHAO, Shenzhen (CN); Jie QIAN, Shenzhen (CN)

(21) Appl. No.: 16/867,174

(22) Filed: May 5, 2020

Related U.S. Application Data
(63) Continuation of application No. PCT/CN2017/113705, filed on Nov. 30, 2017.

(51) Int. Cl. H04N 5/232; G03B 3/10; G02B 7/04

(52) U.S. Cl. CPC H04N 5/23212; G02B 7/04; G03B 3/10

(57) ABSTRACT

The present disclosure provides a focusing method for an electronic device having a camera. The focusing method includes while capturing a target scene, determining a change in a relative position between the electronic device and the target scene. The relative position includes a distance between the electronic device and the target scene and/or an orientation of the target scene with respect to the electronic device. The focusing method further includes determining a focusing scheme according to the change in the relative position between the electronic device and the target scene; and focusing on an object to be tracked and photographed according to the determined focusing scheme. The object to be tracked and photographed is a part of the target scene.

### CROSS-REFERENCE TO RELATED APPLICATION

This application is a continuation of International Application No. PCT/CN2017/113705, filed Nov. 30, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure generally relates to the field of computer technology and, more particularly, relates to a focusing method, an electronic device, and a readable storage medium.

### BACKGROUND

When a picture captured by a camera is out of focus, the colors between the pixels are relatively uniform, and thus the visual effect is that the picture is blurred. In order to have a clear display of a picture, it usually requires the picture being in focus. At present, many cameras have an autofocus function. The autofocus methods include a phase focus method and a contrast detection auto focus (CDAF) method. Because the phase focus method relies on the support of a special sensor, the CDAF method is the focusing method adopted by the majority of cameras. The general principle of the CDAF method is as follows:

1. When the camera module is out of focus, the camera module continues to adjust in a certain direction. In this process, the contrast gradually increases.

2. When the contrast reaches the highest level, because the camera module does not immediately realize that the contrast has reached the highest level, the camera module continues to adjust in the certain direction.

3. When the adjustment angle of the camera module is too large, the contrast starts to decrease, and the camera module then realizes that it has missed the best focus position after finding that the contrast has decreased.

4. The camera module adjusts itself back to achieve the highest contrast to complete the focusing process.

It can be seen that the CDAF method requires multiple iterations to search for the focus position with the highest contrast, so the focusing speed is limited. If the object to be photographed changes its position in real time, the focusing speed is even lower. Therefore, how to increase the focusing speed becomes a technical issue that is being studied by researchers in the field.

### SUMMARY

One aspect of the present disclosure provides a focusing method for an electronic device having a camera. The focusing method includes while capturing a target scene, determining a change in a relative position between the electronic device and the target scene. The relative position includes a distance between the electronic device and the target scene and/or an orientation of the target scene with respect to the electronic device. The focusing method further includes determining a focusing scheme according to the change in the relative position between the electronic device and the target scene; and focusing on an object to be tracked and photographed according to the determined focusing scheme. The object to be tracked and photographed is a part of the target scene.

Another aspect of the present disclosure provides an electronic device. The electronic device includes a processor, a memory, and a camera. The memory is configured to store program instructions, and the processor is configured to call the program instructions stored in the memory to execute a focusing method. The method includes determining, when the electronic device captures a target scene, a change in a relative position between the electronic device and the target scene. The relative position includes a distance between the electronic device and the target scene and/or an orientation of the target scene with respect to the electronic device. The focusing method further includes determining a focusing scheme according to the change in the relative position between the electronic device and the target scene; and focusing on an object to be tracked and photographed according to the determined focusing scheme. The object to be tracked and photographed is a part of the target scene.

Another aspect of the present disclosure provides a non-transitory computer-readable storage medium containing computer-executable instructions for, when executed by one or more processors, performing a focusing method for an electronic device having a camera. The focusing method includes determining, when the electronic device captures a target scene, a change in a relative position between the electronic device and the target scene. The relative position includes a distance between the electronic device and the target scene and/or an orientation of the target scene with respect to the electronic device. The focusing method further includes determining a focusing scheme according to the change in the relative position between the electronic device and the target scene; and focusing on an object to be tracked and photographed according to the determined focusing scheme. The object to be tracked and photographed is a part of the target scene.

Other aspects of the present disclosure can be understood by those skilled in the art in light of the description, the claims, and the drawings of the present disclosure.

### BRIEF DESCRIPTION OF THE DRAWINGS

In order to more clearly illustrate the technical solutions in various embodiments of the present disclosure, the drawings used in the description of the embodiments will be briefly described below. It is obvious that the drawings in the following description are some embodiments of the present disclosure, and for those of ordinary skill in the art, other drawings may also be obtained according to these drawings without creative effort.

FIG. 1 illustrates a schematic flowchart of an exemplary focusing method according to various embodiments of the present disclosure;

FIG. 2 illustrates a schematic flowchart of another exemplary focusing method according to various embodiments of the present disclosure;

FIG. 3 illustrates a schematic flowchart of another exemplary focusing method according to various embodiments of the present disclosure;

FIG. 4 illustrates a structural diagram of an exemplary electronic device according to various embodiments of the present disclosure; and

FIG. 5 illustrates a structural diagram of another exemplary electronic device according to various embodiments of the present disclosure.

### DETAILED DESCRIPTION OF THE EMBODIMENTS

In the following, the technical solutions in various embodiments of the present disclosure will be described with reference to the accompanying drawings. It is obvious that the described embodiments are only a part of embodiments of the present disclosure, but not all the embodiments. Other embodiments obtained by those skilled in the art based on various embodiments of the present disclosure without creative efforts are within the scope of the present disclosure.

The electronic device described in various embodiments of the present disclosure may be a camera or other terminal that is configured with a camera (or a camera module), such as a mobile phone, an unmanned aerial vehicle, a monitor, etc. In one embodiment, a camera that is configured on an unmanned aerial vehicle (UAV) is taken as an example for illustration.

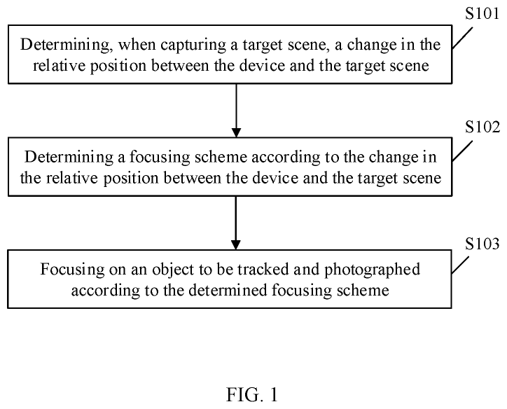

FIG. 1 illustrates a schematic flowchart of an exemplary focusing method according to various embodiments of the present disclosure. Referring to FIG. 1, the focusing method may include the followings.

In S101, the electronic device may determine, when capturing a target scene, a change in the relative position between the electronic device and the target scene.

Specifically, the target scene may refer to an object to be photographed by the electronic device. The target scene may be a landscape, a moving object such as a person, or a combination of a moving object and a landscape, etc. In one embodiment, the device may need to determine the change in the relative position between the electronic device and the target scene. The relative position may include a distance, an orientation (or a direction), or a distance and an orientation. In one embodiment, the distance may be an approximate distance or an accurate distance, and the orientation may be an approximate orientation or an accurate orientation. For example, the relative position between the electronic device and the target scene may be obtained multiple times in a period of time, and the change in the relative position between the electronic device and the target scene may be determined by comparing the multiple obtained relative positions. For illustrative purposes, two schemes are provided below for determining the change in the relative position between the electronic device and the target scene.

In one scheme, the electronic device according to various embodiments of the present disclosure may be configured with at least one of an inertial measurement unit (IMU), a visual odometry (VO), and a global positioning system (GPS). In this case, when capturing a target scene, the electronic device may be able to determine the change in the relative position between the electronic device and the target scene by determining the change in the relative position between the electronic device and the target scene according to the changes in the data recorded in the at least one of the IMU, the VO, and the GPS disposed in the electronic device.

For example, the electronic device may measure the angular velocity and acceleration of the electronic device in three-dimensional space according to the IMU, and calculate the attitude of the object to determine the change in the distance of the electronic device from the target scene (strictly speaking, the change in the distance from the camera on the electronic device to the target scene). The electronic device may also continuously position itself according to the GPS, and thus determine the change in the distance of the electronic device from the target scene. In addition, the electronic device may also analyze the collected image frames through the VO, and thus determine the change in the distance between the electronic device and the target scene. Further, the electronic device may also analyze the collected image frames through the VO, and thus determine the change in the orientation between the electronic device and the target scene.

It should be understood that, in some embodiments, the change in the relative position between the electronic device and the target scene may be determined according to the changes in the data recorded in at least two of the IMU, the VO, and the GPS disposed in the electronic device. For example, the GPS may be able to approximately locate the current position of the electronic device, and the IMU or the VO may be able to sense the orientation to which the camera on the electronic device points. Therefore, the changes in the data recorded in at least two of the IMU, the VO, and the GPS may be able to reflect the change in the relative position between the electronic device and the target scene.

In another scheme, when capturing a target scene, the electronic device may determine the change in the relative position between the electronic device and the target scene through the following exemplary steps. First, at least two preview frames may be obtained by continuously capturing the target scene. The target scene may include a marker. Further, the change in the relative position between the electronic device and the target scene may be determined according to the relative size of the area occupied by the marker in the at least two preview frames.

In one embodiment, the preview frame may refer to the image data obtained by the camera of the electronic device when capturing the target scene. Because the focusing process has not been completed, the image data is generally not used to generate a picture. In one embodiment, the image data obtained by the camera but not necessarily used to generate a picture may become a preview frame.

In one embodiment, the marker may be an object that exists in each of the at least two preview frames. For example, when the electronic device is to capture a picture of a person standing in a certain scene through a camera, the camera may perform a focusing process before determining the captured picture, and the focusing process may include continuously capturing multiple preview frames of the person in the certain scene. Since each preview frame of the multiple preview frames may include the person, the person may be used as a marker.

In addition, determining the change in the relative position between the electronic device and the target scene may include the following exemplary methods. In one method, an amount of change in the relative position between the electronic device and the target scene may be calculated. In this case, the amount of change in the relative position may be used to indicate whether the electronic device and the target scene are getting closer or farther, or may be a numerical value used to indicate the change in the distance or in the angle, or the angle to which the relative position is changed. In another method, a subsequent change trend of the relative position between the electronic device and the target scene may be predicted. In another method, the changed value in the relative position between the electronic device and the target scene may be calculated and the subsequent change trend of the relative position between the electronic device and the target scene may also be predicted.

For example, in two preview frames that were captured one after another, when the area occupied by a person in the preview frame captured earlier is smaller than the area occupied by the person in the preview frame captured later, the distance from the electronic device to the target scene may be determined as getting shorter, i.e., the electronic device and the target scene may be determined as getting closer. However, when the area occupied by the person in the preview frame captured earlier is larger than the area occupied by the person in the preview frame captured later, the distance from the electronic device to the target scene may be determined as getting longer, i.e., the electronic device and the target scene may be determined as getting farther.

In some embodiments, the changed value of the distance between the electronic device and the target scene may also be estimated based on the size of the person in the two image frames and the imaging principle. In addition, because the capturing time interval between the frame captured earlier and the frame captured later may also be calculated, the electronic device may be able to calculate the changing speed of the distance between the electronic device and the target scene according to the changed value of the distance and the capturing time interval between the two frames, such that the subsequent change trend of the relative position between the electronic device and the target scene may be predicted.

Further, the marker may not be limited to any specific selections in various embodiments of the present disclosure. For example, the marker may be human eyes, nose, mouth, or any other appropriate scene that exists in each of the multiple preview frames. In some embodiments, multiple markers may be used. As such, by summarizing the changes in the relative sizes of the multiple markers in multiple preview frames, the change in the distance between the electronic device and the target scene may be determined. In the following, various implementation examples of summarizing the changes in the relative sizes of multiple markers are provided for further illustration.

In one embodiment, M number of markers may be configured in advance (M is a natural number greater than or equal to 2). When the changes of more than half of the M markers in the multiple preview frames all indicate that the distance between the electronic device and the target scene is getting shorter, the electronic device and the target scene may be determined as getting closer. However, when the changes of more than half of the M markers in the multiple preview frames all indicate that the distance between the electronic device and the target scene is getting longer, the electronic device and the target scene may be determined as getting farther.

In another example, M markers may be configured in advance (M is a natural number greater than or equal to 2). According to the change in the size of each marker in the multiple preview frames, the displacement of the electronic device relative to the target scene may be calculated; then, the M displacements calculated based on the M markers may be averaged; finally, whether the electronic device and the target scene are getting closer or farther, i.e., whether the distance between the electronic device and the target scene is getting shorter or longer, may be determined according to the average value.

It should be understood that the electronic device may be able to track markers in a preview frames by analyzing the pixels in the picture (or the preview frame), and the details of the implementation is known to those skilled in the art, and will not be described here.

In S102, the electronic device may determine a focusing scheme according to the change in the relative position between the electronic device and the target scene.

For example, the relative position between the electronic device and the target scene mentioned herein may refer to the relative position of the front side of the camera on the electronic device relative to the target scene. According to various embodiments of the present disclosure, the change in the relative position between the electronic device and the target scene may be used to determine a focusing scheme. The focusing scheme may include a focusing direction (e.g. a direction to which the focus is changed), a focusing speed (e.g., a speed at which the focus is changed), etc. that are related to adjusting the focus of the camera. It should be noted that the focusing scheme may also include, corresponding to a zero focusing speed, locking the current focus. In the existing technology, the camera performs a test to determine the focusing direction. When the test result is incorrect, the camera performs a test again in a different direction until the test result is right. According to various embodiments of the present disclosure, the focusing direction may be directly determined according to the change in the relative position between the electronic device and the target scene. Therefore, the focusing method according to various embodiments of the present disclosure may be more targeted and may have a high focusing speed.

In one embodiment, the change in the relative position between the electronic device and the target scene may include an amount of change in the relative position between the electronic device and the target scene. Assuming the relative position includes a distance, then, when the distance from the electronic device to the target scene becomes shorter, the focusing scheme may be used to instruct the camera module of the electronic device to adjust the focus closer. When the distance from the electronic device to the target scene becomes longer, the focusing scheme may be used to instruct the camera module of the electronic device to adjust the focus farther.

In one embodiment, the change in the relative position between the electronic device and the target scene may include a predicted subsequent change trend of the relative position between the electronic device and the target scene. Assuming that the relative position includes a distance, then when the distance from the electronic device to the target scene shows a trend of getting shorter, the focusing scheme may then be used to instruct the camera module of the electronic device to adjust the focus closer. When the distance from the electronic device to the target scene shows a trend of getting longer, the focusing scheme may then be used to instruct the camera module of the electronic device to adjust the focus farther.

In one embodiment, the change in the relative position between the electronic device and the target scene may include a predicted subsequent change trend of the relative position between the electronic device and the target scene and an amount of change in the relative position between the electronic device and the target scene. Assuming that the relative position includes a distance, then, whether the focus needs to be adjusted closer or farther may be determined by combining the factors in both aspects.

Moreover, in addition to the change in the relative position between the electronic device and the target scene when determining the focusing scheme, a focusing parameter may also be used. For example, before the electronic device determines the focusing scheme according to the change in the relative position between the electronic device and the target scene, the electronic device may first track the object to be focused and generate a focusing parameter according to the edge pixels of the object to be focused. The focusing parameter may be used to indicate the depth of focus, that is, to indicate the changed size of the focus, and the electronic device may subsequently determine a focusing scheme according to the change in the relative position between the electronic device and the target scene and the focusing parameter.

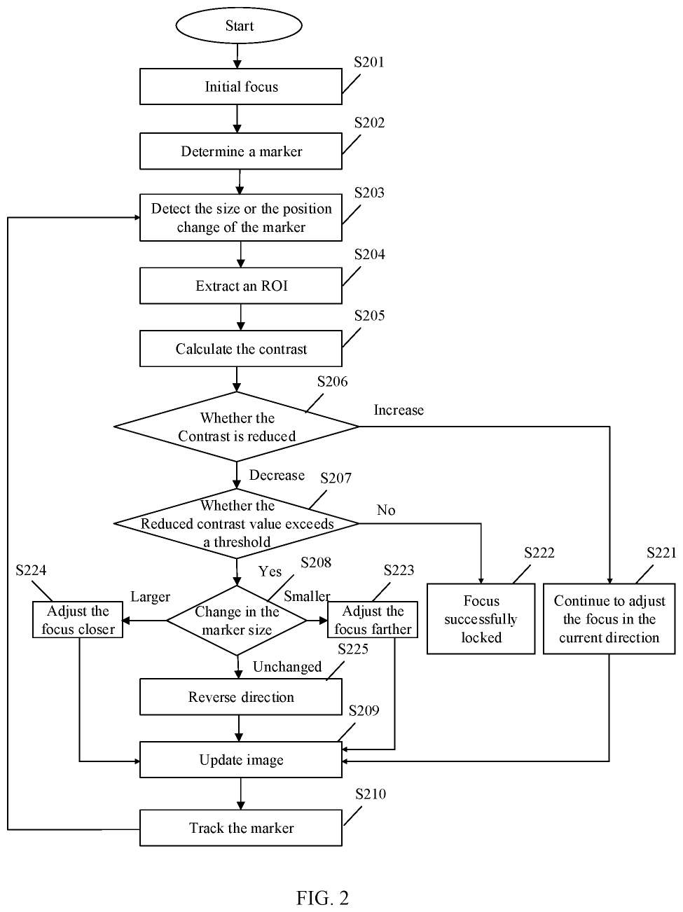

FIG. 2 illustrates a schematic flowchart of another exemplary focusing method according to various embodiments of the present disclosure. Referring to FIG. 2, in one embodiment, the focusing method may be used for adjust the focus of a camera. When the focusing process starts, camera may have an initial focus (S201). Further, a marker may be determined (S202), and then the change in the size or position of the marker in the new preview frame may be determined (S203). The electronic device may also extract a region of interest (ROI) in the latest preview frame (S204), and calculate the contrast according to the ROI (S05).

The method may further include determining whether the contrast is reduced (S206). When the contrast is increased relative to the previous preview frame, adjusting the focus in the current direction may be continued (S221). When the contrast is decreased, the method may further include determining whether the reduced value of the contrast exceeds a preset threshold (S207). When the reduced value is not larger than the preset threshold, the current focus may be locked as the correct focus (S222); while when the reduced value exceeds the threshold, the method may further include determining whether the marker in the preview frame becomes larger (S208). When the marker becomes smaller, the focus may then be adjusted to be farther away (S223). When the marker becomes larger, the focus may be adjusted to be closer (S224). When the size of the marker remains nearly unchanged, the focusing direction may be reversed (S225). Then, the resulting effect after adjusting the focus may be updated to the current image data, and may be display in a preview frame (S209). Subsequent tracking of the marker may be continued (S210), so as to further adjust the focus based on the newly obtained preview frame. It should be noted that the comparison involved in the process described above refers to comparing the current preview frame with the previous preview frame.

In another embodiment, when the relative position includes a distance, the electronic device may subsequently determine the focusing speed based on the changing speed of the distance between the electronic device and the target scene. For example, when it is determined that the electronic device and the target scene are getting closer and the speed of getting closer is higher than a preset threshold, the electronic device may adjust the focus closer at a high speed. However, when it is determined that the electronic device and the target scene are getting closer and the speed of getting closer is lower than the preset threshold, the electronic device may adjust the focus closer at a low speed. In another example, when it is determined that the electronic device and the target scene are getting farther and the speed of getting farther is higher than the preset threshold, the electronic device may adjust the focus farther at a high speed. However, when it is determined that the electronic device and the target scene are getting farther and the speed of getting closer is lower than the preset threshold, the electronic device may adjust the focus farther at a low speed.

It should be understood that, when the electronic device and the target scene become farther or closer at a faster speed, the focusing speed may be increased accordingly, and thus the user may not need to wait much more time for focusing. In cases where the electronic device and the target scene are getting much farther or much closer between the two preview frames, but the focusing speed cannot keep up, the overall time for the focusing process may be greatly increased. However, in cases where the electronic device and the target scene are getting farther or closer at a slow speed, a high focusing speed may easily cause over focusing, e.g., passing the correct focus. Therefore, according to various embodiments of the present disclosure, a corresponding focusing speed is determined based on the changing speed of the distance between the electronic device and the target scene, such that the electronic device may be able to complete the focusing process as quick as possible.

Returning to FIG. 1, in S103, the electronic device may focus on an object to be tracked and photographed according to the determined focusing scheme.

For example, the object to be tracked and photographed may be a part of the target scene. When performing the focusing process, since the object to be tracked and photographed is a key object to be photographed, the focusing scheme determined above may be adopted to perform the focusing process. It should be understood that, the electronic device (for example, a UAV) may continuously track and capture a certain scene (for example, a flying bird) using a camera. During this process, the certain scene may be the key object to be photographed by the UAV and the movement status of the certain scene may change. Therefore, the electronic device may need to focus on the certain scene in real time. In such a case, the focusing scheme determined in various embodiments of the present disclosure may be used to achieve fast and accurate focus on the certain scene.

According to the method illustrated in FIG. 1, the electronic device may determine the change in the relative position between the electronic device and the target scene when capturing the target scene. The electronic device may then predict the correct direction for adjusting the focus based on the change in the relative position between the electronic device and the target scene. Further, the electronic device may, instead of blindly testing whether the focusing direction is correct, determine the focusing scheme based on the predicted result. Therefore, the focusing method according to various embodiments of the present disclosure may be more targeted and may have a high focusing speed.

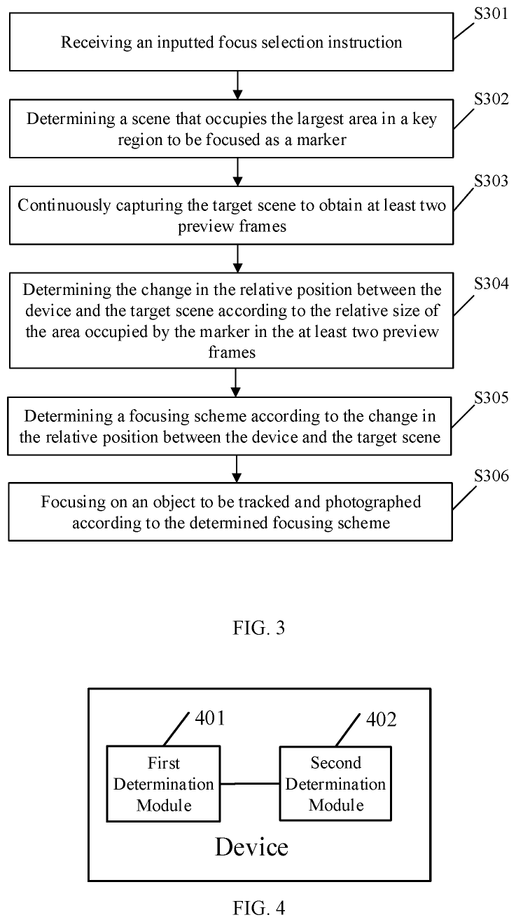

The present disclosure also provides another focusing method. FIG. 3 illustrates a schematic flowchart of another exemplary focusing method according to various embodiments of the present disclosure. Referring to FIG. 3, the focusing method may be adopted by an electronic device to capture a target scene, and the focusing method may include the followings.

In S301, the electronic device may receive an inputted focus selection instruction.

In one embodiment, the focus selection instruction may be inputted through a touch display screen, or may be inputted through voice control, or through any other appropriate method. The focus selection instruction may be used to indicate a key region to be focused. For example, when a user sees a preview frame displayed on the touch display screen of the electronic device, plans to specifically focus on a certain region, the certain region may be clicked or touched such that the electronic device may be able to focus on the certain region. In this case, the corresponding click operation may be regarded as a focus selection instruction.

In S302, the electronic device may determine a scene that occupies the largest area in a key region to be focused as a marker. For example, the marker described above may be a scene with obvious features (e.g., the color is evident, the outline profile is more obvious, etc.). In one embodiment, the marker may be a person, a landscape, a human eye, a nose, a mouth, etc.

In another example, the marker may be an object to be focused. In this case, the marker may not be the scene that occupies the largest area in the key region to be focused.

In S303, the electronic device may continuously capture the target scene to obtain at least two preview frames. For example, the target scene may refer to the object to be photographed. The target scene may be a landscape, a person, or a combination of a person and a landscape, etc. In various embodiments of the present disclosure, the electronic device may need to determine the change in the relative position between the electronic device and the target scene. The relative position may include a distance, an orientation (or a direction), or a distance and an orientation. In one embodiment, the distance may be an approximate distance or an accurate distance, and the orientation may be an approximate orientation or an accurate orientation. In one embodiment, the preview frame may refer to the image data obtained by the camera of the electronic device when capturing the target scene.

Because the focusing process has not been completed, the image data is generally not used to generate a picture. In one embodiment, the image data obtained by the camera but not necessarily used to generate a picture may become a preview frame. It should be noted that the target scene may include a marker described above, that is, each of the at least two preview frames obtained by capturing the target scene may include the marker.

In S304, the electronic device may determine the change in the relative position between the electronic device and the target scene according to the relative size of the area occupied by the marker in the at least two preview frames.

For example, the relative position may include a distance between the electronic device and the target scene, and two preview frames may be captured one after another (e.g., the two preview frames may be captured sequentially). When the area occupied by the target scene in the preview frame captured earlier is smaller than the area occupied by the target scene in the preview frame captured later, the distance from the electronic device to the target scene may be determined as getting shorter, i.e., the electronic device and the target scene may be determined as getting closer. However, when the area occupied by the target scene in the preview frame captured earlier is larger than the area occupied by the target scene in the preview frame captured later, the distance from the electronic device to the target scene may be determined as getting longer, i.e., the electronic device and the target scene may be determined as getting farther.

In some embodiments, multiple markers may be used. As such, by summarizing the changes in the relative sizes of the multiple markers in multiple preview frames, the change in the distance between the electronic device and the target scene may be determined. In the following, implementation examples of summarizing the changes in the relative sizes of multiple markers are provided for further illustration.

In one embodiment, M markers may be configured in advance (M is a natural number greater than or equal to 2). When the changes of more than half of the M markers in the multiple preview frames all indicate that the distance between the electronic device and the target scene is getting shorter, the electronic device and the target scene may be determined as getting closer. However, when the changes of more than half of the M markers in the multiple preview frames all indicate that the distance between the electronic device and the target scene is getting longer, the electronic device and the target scene may be determined as getting farther.

In another example, M markers may be configured in advance (M is a natural number greater than or equal to 2). According to the change in the size of each marker in the multiple preview frames, the displacement of the electronic device relative to the target scene may be calculated. Then, the M displacements calculated based on the M markers may be averaged. Finally, whether the electronic device and the target scene are getting closer or farther, i.e., whether the distance between the electronic device and the target scene is getting shorter or longer, may be determined according to the average value.

It should be understood that the electronic device may be able to track markers in a preview frames by analyzing the pixels in the picture (or the preview frame), and the details of the implementation is known to those skilled in the art, and will not be described here.

In S305, the electronic device may determine a focusing scheme according to the change in the relative position between the electronic device and the target scene.

For example, the relative position between the electronic device and the target scene mentioned here may refer to the relative position of the front side of the camera on the electronic device relative to the target scene. According to various embodiments of the present disclosure, the relative position between the electronic device and the target scene may be used to determine the focusing scheme. In the existing technology, the camera performs a test to determine the focusing direction, and when the test result is incorrect, the camera performs a test again in a different direction until the test result is right.

According to various embodiments of the present disclosure, the focusing direction may be directly determined according to the change in the distance between the electronic device and the target scene. Therefore, the focusing method according to various embodiments of the present disclosure may be more targeted and may have a high focusing speed. In one embodiment, when the distance from the electronic device to the target scene becomes shorter, the focusing scheme may be used to instruct the camera module of the electronic device to adjust the focus closer. However, when the distance from the electronic device to the target scene becomes longer, the focusing scheme may be used to instruct the camera module of the electronic device to adjust the focus farther.

Referring to FIG. 2, in one embodiment, the focusing method may be used for adjust the focus of a camera. When the focusing process starts, camera may have an initial focus (S201). Further, a marker may be determined (S202), and then the change in the size or position of the marker in the new preview frame may be determined (S203). The electronic device may also extract a region of interest (ROI) in the latest preview frame (S204), and calculate the contrast according to the ROI (S05).

The method may further include determining whether the contrast is reduced (S206). When the contrast is increased relative to the previous preview frame, adjusting the focus in the current direction may be continued (S221). When the contrast is decreased, the method may further include determining whether the reduced value of the contrast exceeds a preset threshold (S207). When the reduced value is not larger than the preset threshold, the current focus may be locked as the correct focus (S222); while when the reduced value exceeds the threshold, the method may further include determining whether the marker in the preview frame becomes larger (S208). When the marker becomes smaller, the focus may then be adjusted to be farther away (S223). When the marker becomes larger, the focus may be adjusted to be closer (S224). When the size of the marker remains nearly unchanged, the focusing direction may be reversed (S225). Then, the resulting effect after adjusting the focus may be updated to the current image data, and may be display in a preview frame (S209). Subsequent tracking of the marker may be continued (S210), so as to further adjust the focus based on the newly obtained preview frame. It should be noted that the comparison involved in the process described above refers to comparing the current preview frame with the previous preview frame.

In another embodiment, when the relative position includes a distance, the electronic device may subsequently determine the focusing speed based on the changing speed of the distance between the electronic device and the target scene. For example, when it is determined that the electronic device and the target scene are getting closer and the speed of getting closer is higher than a preset threshold, the electronic device may adjust the focus closer at a high speed. However, when it is determined that the electronic device and the target scene are getting closer and the speed of getting closer is lower than the preset threshold, the electronic device may adjust the focus closer at a low speed. In another example, when it is determined that the electronic device and the target scene are getting farther and the speed of getting farther is higher than the preset threshold, the electronic device may adjust the focus farther at a high speed. However, when it is determined that the electronic device and the target scene are getting farther and the speed of getting closer is lower than the preset threshold, the electronic device may adjust the focus farther at a low speed.

It should be understood that, when the electronic device and the target scene become farther or closer at a faster speed, the focusing speed may be increased accordingly, and thus the user may not need to wait much more time for focusing. In cases where the electronic device and the target scene are getting much farther or much closer between the two preview frames, but the focusing speed cannot keep up, the overall time for the focusing process may be greatly increased. However, in cases where the electronic device and the target scene are getting farther or closer at a slow speed, a high focusing speed may easily cause over focusing, e.g., passing the correct focus. Therefore, according to various embodiments of the present disclosure, a corresponding focusing speed is determined based on the changing speed of the distance between the electronic device and the target scene, such that the electronic device may be able to complete the focusing process as quick as possible.

In S306, the electronic device may focus on the object to be tracked and photographed according to the determined focusing scheme.

For example, the object to be tracked and photographed may be a part of the target scene. When performing the focusing process, since the object to be tracked and photographed is a key object to be photographed, the focusing scheme determined above may be adopted to perform the focusing process. It should be understood that, the electronic device (for example, a UAV) may continuously track and capture a certain scene (for example, a flying bird) using a camera, and during this process, the certain scene may be the key object to be photographed by the UAV and the movement status of the certain scene may change; therefore, the electronic device may need to focus on the certain scene in real time. In such a case, the focusing scheme determined in various embodiments of the present disclosure may be used to achieve fast and accurate focus on the certain scene.

According to the method illustrated in FIG. 3, the electronic device may determine the change in the relative position between the electronic device and the target scene when capturing the target scene. The electronic device may then predict the correct direction for adjusting the focus based on the change in the relative position between the electronic device and the target scene. Further, the electronic device may, instead of blindly testing whether the focusing direction is correct, determine the focusing scheme based on the predicted result. Therefore, the focusing method according to various embodiments of the present disclosure may be more targeted and may have a high focusing speed.

In the following, examples will be provided to illustrate a gimbal-based follow-up control apparatus and control electronic device according to various embodiments of the present disclosure. FIG. 4 illustrates a structural diagram of an exemplary electronic device according to various embodiments of the present disclosure. Referring to FIG. 4, the electronic device 40 may include a first determination module 401 and a second determination module 402. The details of each module is described as follows.

The first determination module 401 may be configured to, when capturing a target scene, determine the change in the relative position between the electronic device and the target scene, where the relative position may include a distance and/or an orientation.

The second determination module 402 may be configured to determine a focusing scheme according to the change in the relative position between the electronic device and the target scene.

The electronic device may focus on the object to be tracked and photographed according to the determined focusing scheme, where the object to be tracked and photographed may be a part of the target scene.

In one embodiment, when capturing the target scene, the first determination module 401 may determine the change in the relative position between the electronic device and the target scene through the following exemplary steps. When the relative position includes the distance, the change in the distance between the electronic device and the target scene may be determined according to the changes in the data recorded in at least one of an IMU, a VO, and a GPS disposed in the electronic device; when the relative position includes the orientation, a change in the orientation of the target scene with respect to the electronic device may be determined according to the changes in the data recorded in at least one of an IMU, and a VO disposed in the electronic device.

In one embodiment, when capturing the target scene, the first determination module 401 may determine the change in the relative position between the electronic device and the target scene through the following exemplary steps. First, at least two preview frames may be obtained by continuously capturing the target scene. The target scene may include a marker. Further, the change in the relative position between the electronic device and the target scene may be determined according to the relative size of the area occupied by the marker in the at least two preview frames.

In one embodiment, determining the change in the relative position between the electronic device and the target scene may include determining an amount of change in the relative position between the electronic device and the target scene, and/or predicting a subsequent change trend of the relative position between the electronic device and the target scene. In some embodiments, the marker may be an object to be focused.

In one embodiment, the electronic device 40 may include a receiving module, and a third determination module.

The receiving module may be configured to, before the first determination module 401 continuously captures the target scene to obtain the at least two preview frames, receive an inputted focus selection instruction, where the focus selection instruction may be used to indicate a key region to be focused.

The third determination module may be configured to determine a scene that occupies the largest area in the key region to be focused as the marker.

In one embodiment, the relative position may include a distance, and there may have a total of M markers. When the changes of more than half of the M markers in the at least two preview frames all indicate that the distance between the electronic device and the target scene is getting shorter, the electronic device and the target scene may be determined as getting closer. However, when the changes of more than half of the M markers in the at least two preview frames all indicate that the distance between the electronic device and the target scene is getting longer, the electronic device and the target scene may be determined as getting farther. In one embodiment, M may be a natural integer.

In another embodiment, the relative position may include a distance. When the distance from the electronic device to the target scene becomes shorter, the focusing scheme may be used to instruct the camera module of the electronic device to adjust the focus closer. When the distance from the electronic device to the target scene becomes longer, the focusing scheme may be used to instruct the camera module of the electronic device to adjust the focus farther.

In some other embodiments, before the electronic device determines the focusing scheme according to the change in the relative position of the electronic device and the target scene, the electronic device may track the object to be focused and generate a focusing parameter according to the edge pixels of the object to be focused.

In one embodiment, the electronic device determining the focusing scheme according to the change in the relative position between the electronic device and the target scene may include the electronic device determining the focusing scheme according to the relative position according to the change in the distance between the electronic device and the target scene and the focusing parameter.

For the detail implementation of the electronic device shown in FIG. 4, reference may be made to the corresponding description of the methods illustrated in FIG. 1 and FIG. 3 according to various embodiments of the present disclosure.

According to the electronic device illustrated in FIG. 4, the electronic device may determine the change in the relative position between the electronic device and the target scene when capturing the target scene. The electronic device may then predict the correct direction for adjusting the focus based on the change in the relative position between the electronic device and the target scene. Further, the electronic device may, instead of blindly testing whether the focusing direction is correct, determine the focusing scheme based on the predicted result. Therefore, the focusing method according to various embodiments of the present disclosure may be more targeted and may have a high focusing speed.

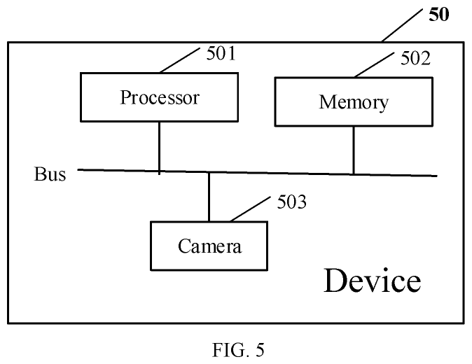

FIG. 5 illustrates a structural diagram of another exemplary electronic device according to various embodiments of the present disclosure. Referring to FIG. 5, the electronic device 50 may include a processor 501, a memory 502, and a camera (or a camera module) 503. The processor 501, the memory 502, and the camera 503 may be connected with each other through a bus.

In one embodiment, the memory 502 may include, but is not limited to, a random access memory (RAM), a read-only memory (ROM), an erasable programmable read only memory (EPROM), or a compact disc read-only memory (CD-ROM). The memory 502 may be configured to store related program instructions and data. The camera 503 may be configured to capture pictures, and thus obtain image data.

In one embodiment, the processor 501 may include a central processing unit (CPU), and the CUP may be a single-core CPU or a multi-core CPU. In other embodiments, the processor 501 may include at least two CPUs.

In one embodiment, the processor 501 in the electronic device 50 may be configured to read the program instructions stored in the memory 502 to perform: when the camera 503 captures a target scene, determining the change in the relative position between the electronic device and the target scene, where the relative position may include a distance and/or an orientation; determining a focusing scheme according to the change in the relative position between the electronic device and the target scene; and focusing on the object to be tracked and photographed according to the determined focusing scheme, where the object to be tracked and photographed may be a part of the target scene.

In one embodiment, when the camera 503 captures the target scene, the processor 502 determining the change in the relative position between the electronic device and the target scene may include: when the relative position includes the distance, determining a change in the distance between the electronic device and the target scene according to the changes in the data recorded in at least one of an IMU, a VO, and a GPS disposed in the electronic device; and when the relative position includes the orientation, determining a change in the orientation of the target scene with respect to the electronic device according to the changes in the data recorded in at least one of an IMU, and a VO disposed in the electronic device.

In one embodiment, the marker may be an object to be focused. When the camera 503 captures the target scene, the processor 502 determining the change in the relative position between the electronic device and the target scene may include: controlling the camera 503 to continuously capture the target scene to obtain at least two preview frames, where the target scene may include a marker; and determining the change in the relative position between the electronic device and the target scene according to the relative size of the area occupied by the marker in the at least two preview frames.

In one embodiment, the processor 502 determining the change in the relative position between the electronic device and the target scene may include determining an amount of change in the relative position between the electronic device and the target scene, and/or predicting a subsequent change trend of the relative position between the electronic device and the target scene.

In one embodiment, before controlling the camera 503 to continuously capture the target scene to obtain the at least two preview frames, the processor may further be configured to: receive an inputted focus selection instruction, where the focus selection instruction may be used to indicate a key region to be focused; and determine a scene that occupies the largest area in the key region to be focused as the marker.

In one embodiment, the relative position may include a distance, and there may have a total of M markers. When the changes of more than half of the M markers in the at least two preview frames all indicate that the distance between the electronic device and the target scene is getting shorter, the electronic device and the target scene may be determined as getting closer. However, when the changes of more than half of the M markers in the at least two preview frames all indicate that the distance between the electronic device and the target scene is getting longer, the electronic device and the target scene may be determined as getting farther. In one embodiment, M may be a natural integer.

In another embodiment, the relative position may include a distance. When the distance from the electronic device to the target scene becomes shorter, the focusing scheme may be used to instruct the camera module of the electronic device to adjust the focus closer. When the distance from the electronic device to the target scene becomes longer, the focusing scheme may be used to instruct the camera module of the electronic device to adjust the focus farther.

In one embodiment, before determining the focusing scheme according to the change in the relative position between the electronic device and the target scene, the processor 502 may be further configured to: track an object to be focused and generate a focusing parameter according to the edge pixels of the object to be focused.

Correspondingly, the processor 502 determining the focusing scheme according to the change in the relative position between the electronic device and the target scene may include: determining the focusing scheme according to the change in the relative position, between the electronic device and the target scene, and the focusing parameter.

For the detail implementation of the electronic device shown in FIG. 5, reference may be made to the corresponding description of the methods illustrated in FIG. 1 and FIG. 3 according to various embodiments of the present disclosure.

According to the electronic device illustrated in FIG. 5, the electronic device may determine the change in the relative position between the electronic device and the target scene when capturing the target scene. The electronic device may then predict the correct direction for adjusting the focus based on the change in the relative position between the electronic device and the target scene. Further, the electronic device may, instead of blindly testing whether the focusing direction is correct, determine the focusing scheme based on the predicted result. Therefore, the focusing method according to various embodiments of the present disclosure may be more targeted and may have a high focusing speed.

It should be noted that the functional modules in various embodiments of the present disclosure may be integrated into one processing unit, or each of the modules may exist separately physically, or two or more modules may be integrated into one unit. The integrated unit described above may be implemented in the form of hardware, or in the form of hardware combined with software functional units.

The above integrated unit implemented in the form of software functional units may be stored in a computer-readable storage medium. The software functional units stored in a storage medium may include a plurality of instructions for making a computer device (which may be a personal computer, a server, or a network device) or an intelligent terminal device or a processor execute part of the steps of the method according to various embodiments of the present invention. The storage media described above may include: a U disk, a mobile hard disk, a read-only memory (ROM), a random access memory (RAM), a magnetic disk, a compact discs, and/or other media that can store program code.

In the various embodiments provided by the present application, it should be understood that the disclosed systems, devices, and methods may be implemented in other manners. For example, the device embodiments described above are merely illustrative. For instance, in various embodiments of the present disclosure, the units are divided or defined merely according to the logical functions of the units, and in actual applications, the units may be divided or defined in another manner. For example, multiple units or components may be combined or integrated into another system, or some features can be ignored or not executed. In addition, the mutual coupling or direct coupling or communication connection shown or discussed may be an indirect coupling or communication connection through some interface, device or unit, and may be in an electrical, mechanical, or other form.

The units described as separate components may or may not be physically separated, and the components displayed as a unit may or may not be physical in a unit, that is, they may be located in one place, or may be distributed to multiple network units. Some or all of the units may be selected according to actual needs to achieve the purpose of the solution of the embodiment.

In addition, each functional unit in each embodiment of the present application may be integrated into one processing unit, or each unit may exist physically separately, or two or more units may be integrated into one unit.

Finally, it should be noted that the above embodiments are merely illustrative of, but not intended to limit, the technical solutions of the present disclosure; although the present disclosure has been described in detail with reference to the above embodiments, those skilled in the art should understand that the technical solutions described in the above embodiments may be modified, or part or all of the technical features may be equivalently replaced; and the modifications or substitutions do not depart from the scope of the technical solutions of various embodiments of the present disclosure.

What is claimed is:

1. A focusing method for an electronic device having a camera, comprising:
while capturing a target scene, determining a change in a relative position between the electronic device and the target scene, wherein the relative position includes a distance between the electronic device and/or the target scene and an orientation of the target scene with respect to the electronic device;
determining a focusing scheme according to the change in the relative position between the electronic device and the target scene; and
focusing on an object to be tracked and photographed according to the determined focusing scheme, wherein the object to be tracked and photographed is a part of the target scene.

2. The method according to claim 1, wherein the determining the change in the relative position between the electronic device and the target scene further includes:
when the relative position includes the distance, determining a change in the distance between the electronic device and the target scene according to changes in data recorded in at least one of an IMU, a VO, and a GPS disposed in the electronic device; and
when the relative position includes the orientation, determining a change in the orientation of the target scene with respect to the electronic device according to changes in data recorded in at least one of the IMU, and the VO disposed in the electronic device.

3. The method according to claim 1, wherein the determining the change in the relative position between the electronic device and the target scene includes:
continuously capturing the target scene to obtain at least two preview frames, wherein the target scene includes a marker; and
determining the change in the relative position between the electronic device and the target scene according to a relative size of an area occupied by the marker in the at least two preview frames.

4. The method according to claim 3, wherein the determining the change in the relative position between the electronic device and the target scene includes:
determining an amount of change in the relative position between the electronic device and the target scene; and/or
predicting a subsequent change trend of the relative position between the electronic device and the target scene.

5. The method according to claim 3, wherein:
the marker is an object to be focused.

6. The method according to claim 3, prior to continuously capturing the target scene to obtain the at least two preview frames, further including:
receiving an inputted focus selection instruction, wherein the focus selection instruction is used to indicate a key region to be focused; and
determining a scene that occupies a largest area in the key region to be focused as the marker.

7. The method according to claim 3, wherein:
the relative position includes the distance;
the target scene includes M markers, wherein M is a natural number;
when changes of more than half of the M markers in the at least two preview frames all indicate that the distance between the electronic device and the target scene is getting shorter, the electronic device and the target scene are determined as getting closer; and
when changes of more than half of the M markers in the at least two preview frames all indicate that the distance between the electronic device and the target scene is getting longer, the electronic device and the target scene are determined as getting farther.

8. The method according to claim 1, wherein:
the relative position includes the distance;
when the distance between the electronic device and the target scene becomes shorter, the focusing scheme is used to instruct a camera module of the electronic device to adjust a focus closer; and
when the distance between the electronic device and the target scene becomes longer, the focusing scheme is used to instruct the camera module of the electronic device to adjust the focus farther.

9. The method according to claim 1, prior to determining the focusing scheme according to the change in the relative position between the electronic device and the target scene, further including:
tracking an object to be focused and generating a focusing parameter according to edge pixels of the object to be focused,
wherein the determining the focusing scheme according to the change in the relative position between the electronic device and the target scene includes:
determining the focusing scheme according to the change in the relative position, between the electronic device and the target scene, and the focusing parameter.

10. An electronic device, comprising:
a processor, a memory, and a camera,
wherein the memory is configured to store program instructions, and the processor is configured to call the program instructions stored in the memory to execute a focusing method, including:
determining, when the camera captures a target scene, a change in a relative position between the electronic device and the target scene, wherein the relative position includes a distance between the electronic device and the target scene and/or an orientation of the target scene with respect to the electronic device;
determining a focusing scheme according to the change in the relative position between the electronic device and the target scene; and
focusing on an object to be tracked and photographed according to the determined focusing scheme, wherein the object to be tracked and photographed is a part of the target scene.

11. The electronic device according to claim 10, wherein when determining the change in the relative position between the electronic device and the target scene, the processor is configured to:
when the relative position includes the distance, determine a change in the distance between the electronic device and the target scene according to changes in data recorded in at least one of an IMU, a VO, and a GPS disposed in the electronic device; and
when the relative position includes the orientation, determine a change in the orientation of the target scene with respect to the electronic device according to changes in data recorded in at least one of the IMU, and the VO disposed in the electronic device.

12. The electronic device according to claim 10, wherein when determining the change in the relative position between the electronic device and the target scene, the processor is configured to:
control the camera to continuously capture the target scene to obtain at least two preview frames, wherein the target scene includes a marker; and
determine the change in the relative position between the electronic device and the target scene according to a relative size of an area occupied by the marker in the at least two preview frames.

13. The electronic device according to claim 12, wherein when determining the change in the relative position between the electronic device and the target scene, the processor is configured to:
determine an amount of change in the relative position between the electronic device and the target scene; and/or
predict a subsequent change trend of the relative position between the electronic device and the target scene.

14. The electronic device according to claim 12, wherein:
the marker is an object to be focused.

15. The electronic device according to claim 12, wherein prior to controlling the camera to continuously capture the target scene to obtain at least two preview frames, the processor is further configured to:
receive an inputted focus selection instruction, wherein the focus selection instruction is used to indicate a key region to be focused; and
determine a scene that occupies a largest area in the key region to be focused as the marker.

16. The electronic device according to claim 12, wherein:
the relative position includes the distance;
the target scene includes M markers, wherein M is a natural number;
when changes of more than half of the M markers in the at least two preview frames all indicate that the distance between the electronic device and the target scene is getting shorter, the electronic device and the target scene are determined as getting closer; and
when changes of more than half of the M markers in the at least two preview frames all indicate that the distance between the electronic device and the target scene is getting longer, the electronic device and the target scene are determined as getting farther.

17. The electronic device according to claim 10, wherein:
the relative position includes the distance;
when the distance between the electronic device and the target scene becomes shorter, the focusing scheme is used to instruct a camera module of the electronic device to adjust a focus closer; and
when the distance between the electronic device and the target scene becomes longer, the focusing scheme is used to instruct the camera module of the electronic device to adjust the focus farther.

18. The electronic device according to claim 10, wherein:
prior to determining the focusing scheme according to the change in the relative position between the electronic device and the target scene, the processor is further configured to track an object to be focused and generate a focusing parameter according to edge pixels of the object to be focused; and
when determining the focusing scheme according to the change in the relative position between the electronic device and the target scene, the processor is configured to determine the focusing scheme according to the change in the relative position, between the electronic device and the target scene, and the focusing parameter.

19. A non-transitory computer-readable storage medium containing computer-executable instructions for, when executed by one or more processors, performing a focusing method for an electronic device having a camera, the focusing method comprising:
determining, when the electronic device captures a target scene, a change in a relative position between the electronic device and the target scene, wherein the relative position includes a distance between the electronic device and the target scene and/or an orientation of the target scene with respect to the electronic device;
determining a focusing scheme according to the change in the relative position between the electronic device and the target scene; and
focusing on an object to be tracked and photographed according to the determined focusing scheme, wherein the object to be tracked and photographed is a part of the target scene.

20. The storage medium according to claim 19, wherein the determining the change in the relative position between the electronic device and the target scene includes:
continuously capturing the target scene to obtain at least two preview frames, wherein the target scene includes a marker; and
determining the change in the relative position between the electronic device and the target scene according to a relative size of an area occupied by the marker in the at least two preview frames.
